(19) United States
(12) Patent Application Publication
(10) Pub. No.: US 2014/0233181 A1
(43) Pub. Date: Aug. 21, 2014

(54) Protective Case Device with Interchangeable Faceplate System

(71) Applicants: Donn K. Harms, Del Mar, CA (US); Patrick Hussey, Boynton Beach, FL (US)

(72) Inventors: Donn K. Harms, Del Mar, CA (US); Patrick Hussey, Boynton Beach, FL (US)

(21) Appl. No.: 14/187,166

(22) Filed: Feb. 21, 2014

Related U.S. Application Data
(60) Provisional application No. 61/767,730, filed on Feb. 21, 2013.

(51) Int. Cl. A45C 11/00; G06F 1/16

(52) U.S. Cl. CPC A45C 11/00; G06F 1/1613
USPC 361/679.56; 206/37

(57) ABSTRACT

A protective case is provided which is configured for a removable engagement with an electronic device such as a smartphone or pad computer. The case may have an auxiliary power source mounted thereon to increase electronic power reserves of the electronic device, or a supplemental antenna which increases the gain of the device antenna when the case is in operable removable engagement with the electronic device.

### BACKGROUND OF THE INVENTION

1. Field of the Invention

The present invention relates generally to protective cases for handheld electronic devices such as smartphones and portable pad type computing devices. More particularly the invention relates to device and system providing a protective cover for handheld electronic devices including cell phones, smartphones, tablets, E-readers, and the like, which provides for an interchangeable faceplate system allowing the user to select from one or both of a front and rear removably engageable faceplate, preferably from a kit containing one or a plurality of the faceplates. The faceplate may be rotatable in its engagement to the case providing a flip-up mode. The device is configured with a plurality of tactical features such that the device is adaptable for employment in extreme environmental conditions.

2. Prior Art

In recent years with the evolution of handheld electronic devices, in particular the smartphone and pad style computers, at ever increasing cost, there has been a concurrent growing need to protect these devices from damage. Typical smartphone devices such as the IPHONE or DROID can cost hundreds of dollars and will contain valuable user data. Consequently, owners have a particular interest to protect them from damage to ensure a reasonable lifespan and continued access to displays and data. For day to day protection, users have more recently conventionally purchased an accessory protective case.

In today's market, most protective cases are in the form of an outer hard or soft shell which engages over the body of the electronic device. Cases are conventionally made from materials including but not limited to plastic, rubber, metal, wood, and combinations thereof. The purpose of the case is to protect the external body and internal hardware components from impact damage if the user drops it on the ground or abrasive surface. Some designs employ shock and impact resistant material in order to accomplish such protection. Other case types known in the art additionally provide a water resistant seal as a barrier in the event the device is accidentally submerged or encounters rain.

Further, the conventional touchscreen-enabled displays of many smartphone devices are a particular area of concern for damage. Damage to the display area will typically prevent the user from employing the screen to communicate with the device, and may in some cases render the electronic device inoperable. As a conventional solution, some case designs employ a touch-enabled transparent barrier communicating over the existing display screen thereby providing an additional protective layer, while allowing the touch enabled features to be employed.

However, many drawbacks with conventional protective cases exist. Firstly, when a user selects a case to purchase, they typically must weigh the decision between style and functionality. Commonly, a slim, slender appearing cover or case which closely follows the streamline dimensions of the body of their electronic device, typically will provide less impact protection compared to a more ruggedized case which appears generally bulkier and is formed from more material in order to protect the enclosed electronic.

If the user desires additional protection features, such as water-proofing or touch screen scratch protection, this typically also results in a substantially bulkier case or device surrounding cover. In general, a bulkier case will tend to hinder the user's ability to carry the smartphone, or pad computer, in a pocket or other small storage location. However, they provide extreme protection, while slim cases provide the user with a means for customizing the aesthetic look of the phone but without compromising the transportability of the smartphone and still providing some degree of protection.

As can be envisioned, this tradeoff results in manufacturers producing case designs which vary widely, depending on the relationship between style and functionality. As such the current options provided in today's market to the consumer can be quite overwhelming.

With ever growing and evolving smartphone technology, it seems that the purpose of the smartphone is departing rapidly from sole use as a means for communication, to use as an everyday tool while venturing out in the world. The list of uses seems to grow without boundaries, from GPS navigation on the road or in the wilderness, to integration into schools, hospitals, and the military.

In particular, the use and integration of smartphones and similar technologies for soldiers out on the field, or policy and fire personnel in tactical situations, continues to grow. This results in the smartphone or pad computer being taken out of typical city environment and the environment for which it was designed, to more extreme combat and tactical environments. Thus protection in these instances requires bulkier, heavier, more ruggedized cases. Each environment of intended use may also require different features in the rugged case. For example a desert environment may warrant a more dust proof and scratch resistant case, while a marine environment will warrant a waterproof and moisture seal case. Currently, there exists no unified smartphone case or case system which provides all types of case protection without having to remove and replace the case from the electronics in its entirety.

It is also well known that users will purchase and employ protective cases solely for their aesthetic appeal, allowing the user to customize the aesthetic look of their smartphone device, while still affording protection. Users are known to have many different cases each having exterior surfaces and finishes of varying style or color, decals, logos, and the like for further affording individual customization as desired by the user. For example, users may employ a case of a certain color to match an outfit, or a different team logo to match their favorite team of a particular game. These type cases are generally slim and thin walled to provide a substantially sleeker protective case still allowing the user to transport it in a pocket or small purse.

Still further, smartphones and pad computers are adapting for use with other components which must be carried for use along with the phone. These separate components add to the contents of a purse or pocket, and tend to become damaged or lost.

One skilled in the art immediately ascertain that the current market of electronic device cases suffers from this inability to seamlessly join the features of both aesthetics and protective functionality within a single case device and unified system. As such the present invention aims to solve this previously unmet need for an electronic device protective case which combines advantages and features of both aesthetics and tactical functionality. Such a device should be configured with a plurality of tactical features and accompanying components facilitating a wide range of use of the enclosed electronic device within many different extreme environments. In addition, such a device should incorporate a system and method for customizing both the aesthetic and tactical and or/operational features which eliminate the conventional need to employ a plurality of different cases for each instance intended of use. Still further, such a device should maintain a substantially slim profile when engaged to the electronic in order to facilitate conventional storage and transportation in a pocket on the users garment, or other limited volume storage location.

Finally, such a case system should provide for the engagement of a plurality of components for use in combination with the phone or pad computer, which are removably engaged to, and in some case part of, the case. This will lessen number of components which become damaged or lost and add utility to the phone which is engaged to the phone or pad computer.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The device herein disclosed and described provides a solution to the shortcomings in prior art and achieves the above noted goals through the provision of a tactical protective case device for handheld electronics configured with an interchangeable faceplate system allowing the user to select from one or both of a front and back removably and/or rotationally engageable faceplate, preferably from a kit comprising a plurality of such faceplates wherein each employs different aesthetic and tactical features and components. The faceplates may be rotatable in their engagement to the case, such that the faceplate can be rotated into a flip-up mode, where a rear surface of the faceplate, being viewable in the flip-up mode, includes at least one utilitarian feature. This may include in vanity mirror, makeup compact, magnifying lens, and other features, and may be provided as a kit of covers or faceplates all of which are easily removably engageable to the case for use in combination with the enclosed phone or computer.

By varying the features and components of the faceplates, both tactical and aesthetic, users may select any one or combination of both front and back faceplates for customizing the case device while maintain the case body in an engagement with their electronic device. Thus only the replacement of the faceplates is required to completely change the functions and aesthetics of the protective case device.

In a particularly preferred mode, the device is provideable to the user in kit mode, comprising a plurality of removably engageable faceplates, thereby allowing the user to selectively engage the faceplates as needed to customize the device for various tactical and aesthetic purposes. It is of particular utility and advantage over prior art in that all these features can be provided within a single case device thereby eliminating the need to purchase a plurality of different cases for each instance of use.

Therefor, users having particular needs for protection or aesthetics, and especially for users whose needs may change frequently, can easily employ the current invention to solve all their needs with a single case device employing the interchangeable faceplate system.

The faceplates can be manufactured in different colors, having patterns, graphic art indicia, logos, or materials allowing the user to choose the desired faceplate to match their current needs, such as matching the case to their outfit or particular team logo for a sports game. Those skilled in the art will recognize that the level of customization in an aesthetics aspect, providing different colors, indicia, patterns, logos, materials and combinations thereof can vary tremendously and should not be considered limited to only these options.

It is of additional utility and advantage that the faceplate system can be employed as an advertising or promotion means for companies and corporations. The faceplate can include advertisement indicia in the form of logos, team logos, business names or graphics, band names, city names, and the like. These advertisement or promotion type faceplates may be provided as a ‘sold separately’ unit, such that users can later customize the case device with the faceplate of their choosing.

From a tactical standpoint, the features and components employed on the faceplates providing tactical utility may vary as well. Preferred tactical features can include, but are not limited to, providing a waterproof seal of the faceplate to the case as well as the case in its entirety to the electronic device, dust sealing means, shock and impact resistant means, illumination components, induction charging means, and various other suitably functional features.

Although the tactical modes of the device are most notably intended for use with soldiers, police offices, and the like, as well as other practical features for everyday use by the average consumer may also be included. For example, an engageable vanity mirror, makeup compact, magnifying lens for viewing small print such as menus, lipstick or mace container, and other features deemed suitable are anticipated within the scope of this patent.

It is noted that those skilled in the art may envision modes of the device wherein the tactical and aesthetic features can be provided by a case device having either one or a combination of the front and rear faceplates being removably engageable, as well as modes where the faceplates are permanently engaged. Thus the descriptions of the preferred modes are provided merely for illustrative purposes of at least some of the intended features within the scope of the invention, and should not be considered limiting in any manner.

In accordance with a first particularly preferred mode, the device comprises a case body adapted for a grip in the palm of a hand of a user. The case body employs means for removable and rotatable engagement to at least one of a front and rear removably engageable faceplate. The means for removable and rotatable engagement preferably include mating fasteners disposed in operative locations on both the case body and faceplates. Examples of at least some preferred mating fasteners providing means for removable and rotatable engagement may include, however without implying limitation thereon; magnets, snap fits, O-rings mating fasteners, tab and slot mating fasteners, spring loaded ball plunger fastener and locking detent, double sided spring loaded ball plunger and receiving cavity with locking detents, double sided spring loaded ball plunger and latching pawl, as well as others.

To facilitate employment of the device is extreme environment, material choice of the case, as well as the faceplates are of particular consideration. In at least one preferred mode, one or both of the case body and faceplates may be manufactured from ballistic grade plastics, plastic laminates, safety rated plastics, metal such as aluminum or stainless steal, carbon fiber, as well as other suitable composite or pure materials. Some examples of ballistic grade plastics suitable may include, but are not limited to, ANSI Z87 or ANSI Z87+ rated polycarbonate or other plastics, as well as EN 166 rated plastics (European standard).

Further, it is particularly preferred in accordance with at least one mode of the device, the case body and faceplates employ ergonomic features and designs in order to facilitate a high degree of ease-of-use and user comfort when holding the device and enclosed electronic in a conventional manner. This may include the provision of a means for an ergonomic registered engagement of at least one of the fingers of a users hands to the case body. Preferably the means for registered engagement corresponds to a substantially ergonomic gripping position of the fingers when the user is gripping the device in a conventional manner.

Still further, it is noted that the some features of the faceplates and case body, such as one or a plurality of illumination components, may require power source means. In at least one preferred mode this can be provided by an onboard power source such as a battery, or induction charging means such as a induction coil. Additionally, the case device may employ means for electrically connecting to the housed electronic device to both draw power from, as well as to communicate power to, the electronic device's existing portable battery. When in an electrical engagement with the electronic device, the case device can draw power from the electronic device to charge the onboard power source, or alternatively may communicate an electrical charge from the induction charging means to the electronic device's battery.

Further, the device preferably employs means for securing the faceplate to the case body in the engaged mode. Although the device is also preferably configured to allow the user to achieve a flipped-up mode for one or both of the front and rear faceplate, it is desired that the faceplates re securely engage with the case when not flipped up. This can include the provision magnet fasteners, tab and slot fasteners, or other suitable means. Moisture and dust sealing means in the engaged mode are also preferably provided, via a sealing member gasket or the like.

It is briefly noted that upon a reading this disclosure, those skilled in the art will recognize various means for carrying out these intended features of the invention. As such it is to be understood that other devices, systems, and components may be configured to carry out these features and are therefor considered to be within the scope and intent of the present invention, and are anticipated.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects, features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1 shows a front view of a first particularly preferred mode of the tactical case device, showing the removable engagement of a front faceplate to the case body.

FIG. 2 shows a side view of the mode of the device of FIG. 1, depicting the front and rear faceplates disengaged from the case body, also showing a preferred set of finger detents disposed on the side edge of the body, providing a means for an ergonomic registered engagement of the fingers of a hand of a user to the device.

FIG. 3 shows a rear view of the first particularly preferred mode of the tactical case device, showing the removable engagement of a rear faceplate to the case body, also depicting some preferred tactical features disposed on the rear faceplate.

FIG. 4 shows a top view of the mode of the device of FIG. 1.

FIG. 5 shows a front view of a particularly preferred as-used mode of the device of FIG. 1, with the front faceplate engaged to the case body, and depicting the front faceplate in a flipped-up mode.

FIG. 6 shows a rear view of a particularly preferred as-used mode of the device of FIG. 1, with the rear faceplate engaged to the case body, and depicting the rear faceplate in a flipped-up mode.

FIG. 7 shows a side view depiction the device in yet another as-used mode, depicting the front faceplate in the flipped-up mode, and the rear faceplate in the engaged mode.

FIG. 8 shows a view of a particularly preferred mode of the rear faceplate comprising various tactical features such as a concealed bottle opener and a container for lipstick or mace.

FIG. 9 shows a side view of the mode of the rear faceplate of FIG. 8.

FIG. 10 shows a top view of the mode of the rear faceplate of FIG. 8.

FIG. 11 shows a view of another particularly preferred mode of the rear faceplate comprising an onboard power source, induction charging means, and means for electrically connecting to the batter of the housed electronic device.

FIG. 12 depicts a side view of the mode of the rear faceplate of FIG. 11.

FIG. 13 shows a view of a sealing member, in the form of a gasket or the like, employable for an engagement between the faceplate and case body to provide a moisture and dust seal and water barrier.

FIG. 14 shows a detailed view of a first particularly preferred mode of the means for removable and rotatable engagement of the faceplate to the case body, provided by a double sided spring loaded ball plunger fastener and mating receiving cavity with detents.

FIG. 15 shows a detailed view of another particularly preferred mode of the means for removable and rotatable engagement of the faceplate to the case body, provided by a pair of mating snap fit type fasteners.

FIG. 16 shows a detailed view of yet another particularly preferred mode of the means for removable and rotatable engagement of the faceplate to the case body, provided by a double sided spring loaded ball plunger fastener and mating latching pawl.

FIG. 17 shows a detailed view of still another particularly preferred mode of the means for removable and rotatable engagement of the faceplate to the case body, provided by complimentary magnetic strip portions engaged to both the case body and faceplate.

FIG. 18 shows a detailed view of a locking tab and slot configuration which can be employed as a means for securing the faceplate to the case body in the engaged mode.

FIG. 19 shows a front view of another particularly preferred mode of the case device employing dust and moisture sealing means provided a slidable cover which can be translated to closed and open positions.

FIG. 20 shows a front view of the mode of the device of FIG. 19 showing the slidably cover in an intermediate position when translating the cover from either a closed or open position.

FIG. 21 shows a sliced view of the device of FIG. 19 as seen along line AA in FIG. 19.

FIG. 22 shows a sliced view of the device of FIG. 20 as seen along line BB in FIG. 20.

FIG. 23 shows a view of still yet another particularly preferred mode of the device employing means for removable engagement of accessory earbud type headphones.

FIG. 24 shows a view of yet another particularly preferred mode of the device, showing the device in a mode configured for relatively larger electronic device such as tablet computers, employing means for removable engagement of accessory headphones.

FIG. 25 shows a view of another particularly preferred mode of the case device, showing the case device in a mode configured for relatively larger electronic device such as tablet computers, employing means for removable engagement of wireless accessory headphones, wherein the engagement of the headphones an in engaged mode to the case device substantially comprise the corner edges of the case device.

FIG. 26 shows the mode of the device of FIG. 25 with the wireless accessory headphones in the engaged mode with the case device.

Other aspects of the present invention shall be more readily understood when considered in conjunction with the accompanying drawings, and the following detailed description, neither of which should be considered limiting.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

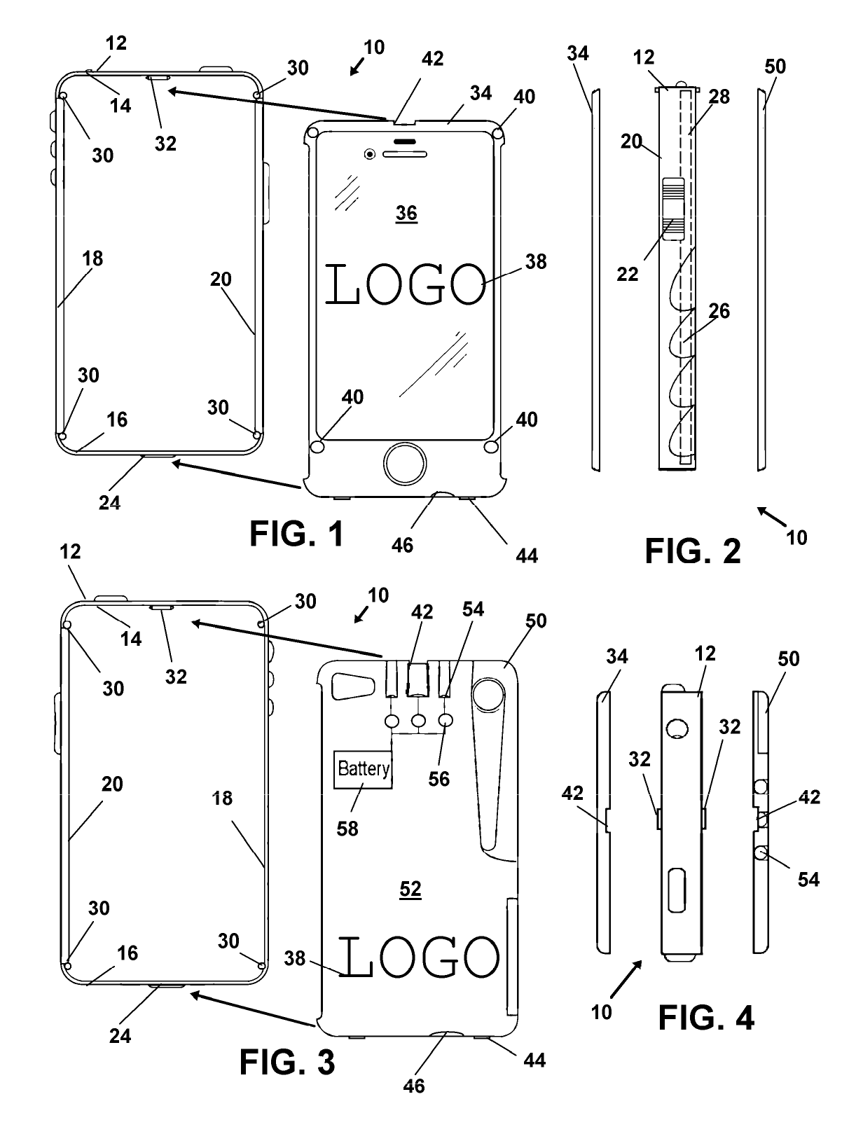

Now referring to drawings in FIGS. 1-26, wherein similar components are identified by like reference numerals, there is seen in FIG. 1-FIG. 7 views of a first particularly preferred mode of the tactical protective case device 10 and interchangeable faceplate system. The device 10 in all preferred modes is intended to provide a protective case device for conventional handheld electronics such as cell phones, smartphones, tablet computers, E-readers, and the like. Tactical and aesthetic utilities are carried out through various features and components disposed on the case body 12 and removably engageable faceplates 34, 50. Thus the device 10 and interchangeable faceplate system described herein, facilitates a means for selecting from one or both of a front 34 and rear 50 faceplate for user customization.

It is noted that features and components providing tactical, advertising, and aesthetic utility of the disclosed case device 10 and system herein may be suitably adapted for employment with any conventional handheld electronic known in the art. Therefor those skilled in the art will quickly ascertain that the disclosed case device 10 is capable of various shape and dimension modifications without departing from the scope and intent of the invention, while such modifications are anticipated. For example, the current depictions in the figures substantially represent a mode of the device 10 having a general shape and dimension adapted for engagement to an iPhone®, however modifications are anticipated such that the device 10 can be shaped to achieve engagement to any conventional handheld electronic device, including other known smartphone devices, tablets, E-readers, and the like.

With that being said, in FIG. 1-FIG. 7, and in accordance with a first particularly preferred mode, the device 10 comprises a case body 12 adapted for a grip in the palm of a hand of a user. The body 12 generally comprises an upper wall 14, lower wall 16, and opposing sidewalls 18, 20 which are configured to engaged at or around the circumferential side edge of an electronic device (not shown) in an as-used mode. The walls 14, 16, 18, 20 may form a continuous and unitarily formed peripheral edge. The body 12 can be formed from conventional materials such as plastic, ballistic grade materials, metal, wood, however may be formed from any material suitable for the intended purpose. However, for mass production, the case body 12 is preferably formed from plastic via conventional techniques such as injection molding or the like.

In some preferred modes the case body 12 is engageable over the electronic device in a frictional slip fit, snap fit, or other suitable manner to provide a means for engagement thereon. In at least one other mode however, the body 12 may be formed in separable components which can be engaged together in a fastened engagement over the electronic device. For example the body 12 can be form from at least two separable parts, for example the top wall 14 and sidewall 18 may comprise one part, and the bottom wall 16 and sidewall 20 may comprise a second part, wherein the parts can snap or otherwise engage together to form the body 12 for a snap fit or frictional slip fit engagement over the electronic device.

FIG. 2 shows a preferred mode of the case body 12 having a sidewall 20 exterior surface employing means for ergonomic registered engagement with the fingers of the hand of the user when gripping the device 10. Currently shown are a plurality of indentations 26 providing such means for ergonomic registered engagement disposed on the exterior surface of at least one of the sidewalls 18, 20 and corresponding to finger positions when the user is gripping the device 10 in the palm of their hand. The indentations 26 when registered with the users grip, will provide an enhanced gripping means by registering the users fingers in the engagement thereto and further maintaining a substantially secure grip on the device 10, as well as providing an ergonomic grip for user comfort.

The device 10 and interchangeable faceplate system disclosed herein allows the user to select from one or both of a front 34 and rear 50 removably engageable faceplate for an engagement to the case body 12. The faceplates 34, 50 of the present invention are preferably configured with at least one tactical and aesthetic feature of which the user can selectively engage to meet their needs. In a particularly preferred kit mode, the user can purchase the case body 12 and a kit containing a plurality of various front 34 and rear 50 faceplates, each configured with different features. By varying the features and components of the faceplates 34, 50, both tactical and aesthetic, users may select any one or combination of both front and back faceplates for customizing the case device 10. It is of particular utility and advantage over prior art in that all these features can be provided within a single case device 10 and kit thereby eliminating the need to purchase a plurality of different cases for each intended instance of use.

FIG. 1 shows a front view of a first particularly preferred mode of the front faceplate 34. The front faceplate 34 preferably includes a transparent touchscreen enabled membrane 36 which when engaged to the case body 12, will register with the existing display of housed smartphones or other electronic. The membrane 36 is intended to provide a layer of protection to the electronic device's display screen while allowing the user employ the existing touchscreen enabled display. The membrane 36 is of suitable material to allow the user to communicate touch gestures of their finger or stylus to the conventional existing capacitive or resistive type touchscreen enable display.

FIG. 3 depicts a front view of a particularly preferred mode of the rear faceplate 50. In this mode the rear faceplate includes an illumination component 54 provided by one or a plurality of LED's. The LED's can comprise one or any suitable combination of strobe lights, spot light, UV light, IR light, or colored light (blue, red, white, for example. In particular, the employment of different colored LED's may provide a tactical feature for signaling others, for example by soldiers in combat.

Each LED may include an individual power switch or button 56 communicating in an electrical engagement with a power source means, such as an onboard battery 58. This will allow the user to selectively employ the desired LED as needed. However, in an additional particularly preferred mode, the power activation means can be provided by a pressure sensitive switch 28 imbedded or otherwise engaged within the sidewall 20 of the case body 12 (FIG. 2). Thus the user gripping the device 10 in a conventional manner can simply squeeze the body 12 to activate the switch 28 for powering the illumination component 54. It is anticipated that those skilled in the art may envision various means for electrically connecting the switch 28 disposed on the body 12 to the illumination means of the rear faceplate 50. This may include a wireless or wired engagement which is completed when the faceplate 50 is engaged to the body 12. Additional illumination means 40 disposed on the front faceplate 34 may also be provided. The purpose of these illumination means 40 will be brought out shortly.

The interchangeable faceplate system herein is provided through the employment of means for removable and rotatable engagement of at least one of a front 34 and rear 50 removably engageable faceplate or the membrane 36, to the case body 12. The means for removable and rotatable engagement preferably include mating fasteners 32, 43 disposed in operative locations on both the case body 12 and faceplates 34, 50, respectively. Examples of at least some preferred modes of the mating fasteners 32, 42 providing means for removable and rotatable engagement are shown in FIGS. 14-17. Currently the fasteners 32, 43 are disposed on an upper edge of the top wall 14 and upper edge of the faceplates 34, 50, respectively shown. Preferred examples, however without implying limitation thereon include mating magnetic strip portions 96 (FIG. 17), snap fit fastener having locking protrusions 88 and receiving cavity with locking detents 86 (FIG. 15), O-rings mating fasteners, tab and slot mating fasteners, spring loaded and biased ball plunger fastener configured for engagement in a locking detent, double sided opposing spring loaded ball plunger 84 and receiving cavity with locking detents 86 (FIG. 14), double sided spring loaded ball plunger 90 and latching pawl 92 (FIG. 16), as well as others. Ideally the removable engagement also provides rotational engagement so that the faceplate or membrane 36 when used to aid the vision of the user, can be changed easily to less or more magnification or optical correction to suit the user, and thereafter rotated out for see-through viewing with or without an illumination component such as in FIG. 7.

Further it is noted and anticipated that the quantity and disposition of the fasteners 32, 42 on the case body 12 and faceplate 34, 50 may be varied as deemed suitable by the designer. As such the current depiction are provided merely for descriptive purposes of portraying the intent of the invention, and should not be considered limiting.

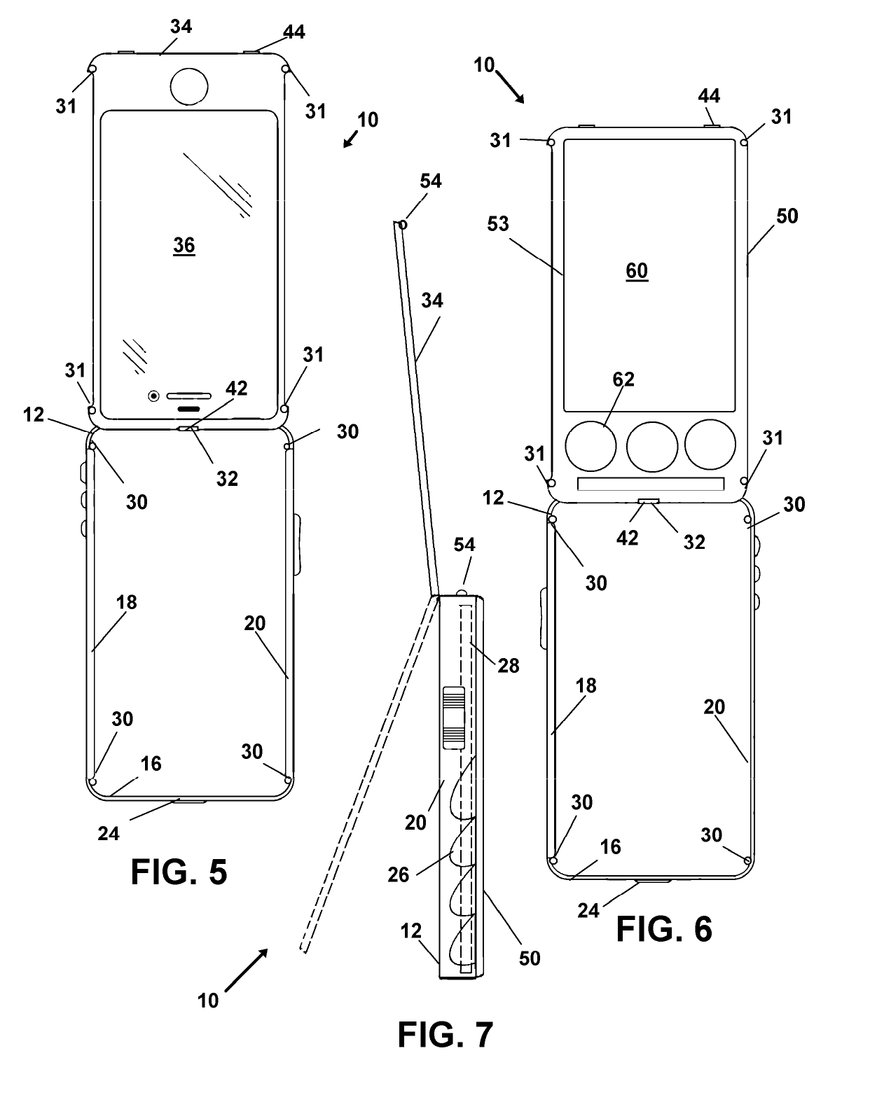

Additionally, there is included means for securing the faceplates 34, 50 in their engagement to the case body 12 in an engaged as-used mode. Although the device is preferably configured to allow the user to achieve a flipped-up mode, for one or both of the front 34 and rear 50 faceplate (shown in FIGS. 5, 6, 7) it is desired that the faceplates 34 50 are securely engaged with the case body 12 when not flipped up, therefor providing a secured as-used mode. This can include the provision of one or a plurality of magnetic mating fasteners 30, 31 disposed one both the case body 12 and faceplates 34, 35 respectively, tab 44 and slot 94 fastener means, or other suitable means. For example, shown in the detailed view of FIG. 18, tab portions 44 may extend from the bottom edge of the faceplates 34, 50 and may register with receiving slots 94 disposed on the bottom wall 16 of the case body 12 for securely engaging and locking the faceplates 34, 50 to the body 12.

As noted, an additional particularly preferred aspect of the present invention is the provision of the faceplates 34, 50 being rotatable in their engagement to the case body 12, such that the faceplate 34, 50 can be rotated into a flip-up mode (FIG. 5, FIG. 6, and FIG. 7). In the flip-up mode, as shown in the exemplar of FIG. 6, a rear surface 52 of the rear faceplate 50 is exposed. This surface 52 may employ features providing utility to the user, for example, in the depiction in FIG. 6, the rear surface 53 may comprise a cosmetic compact including a mirrored surface 60 and cavities 62 for makeup and/or makeup brush (not shown). Thus the user can rotate the rear faceplate 50 into the flip-up mode to access the compact, and then may return the faceplate 50 to the secured engaged mode with the case body 12 when finished to conceal the compact. It is noted that the rear surface 53 of the faceplate 50 may include other components deemed suitable for the intended purpose of providing utility features within the interchangeable faceplate system.

The faceplates 34, 50 additionally preferably include detent lip portion 46 adapted for an engagement with a users thumb or forefinger, to aid them in grasping the lower edge of the faceplate to rotate it up into the flip-up mode. However, a tab, handle, or other component suitable for this intended purpose may also be employed, and are anticipated.

FIG. 5 and FIG. 7 shows another preferred flip-up mode of the device 10 showing the front faceplate 34 rotated into the flip-up mode. In this mode, the transparent membrane 36 preferably has a slight to moderate optical magnification of a surface when viewing therethrough. Also, a light or illumination component 54 can be placed at the distal end of the faceplate 34 to add illumination to the surface under the membrane 36 and powered by small wires engaged around a side edge of the membrane 36 and out of the visual view.

Thus in this engaged mode the membrane 36 will provide a magnification of the users electronic devices' existing display screen, and, may be preferred by users with close up vision deficiencies for reading print such as on menus and newspapers. In addition, when in the flip-up mode as shown for instance in FIG. 7, the front faceplate 34 can be employed as a magnifier for viewing small print in a book, menu, or the like. 54 Concurrently, the user can employ the illumination means 40 disposed on the front surface of the front faceplate 34 as noted previously, in order to illuminate the viewing material during a viewing through the membrane 36. The illumination means can include one or a plurality of LED lights, or other suitable means, which are powered by an onboard power means such as a battery (not shown) and activated via an individual button or switch, or the pressure switch 28 as described previously.

Users having particular needs for protection, tactical features, or aesthetics, can easily employ the current device 10 and system to solve all their needs with a single case device 10 employing the interchangeable faceplate system. The exterior surface 52 of the faceplates 34, 50 can be manufactured in different colors, having patterns, graphic art indicia, logos, or materials allowing the user to choose the desired faceplate 34, 50 to match their needs such as color matching of the device 10 to their outfit or particular team logo for a sports game. Those skilled in the art will recognize that the level of customization in an aesthetics aspect, providing different colors, indicia, patterns, logos, materials and combinations thereof can vary tremendously and should not be considered limited to only these options.

It is of additional utility and advantage that the faceplate system can be employed as an advertising or promotion means. The faceplate 34, 50 can include advertisement indicia in the form of logos, team logos, business names or graphics, band names, city names, and the like. For example, as shown in FIG. 1, indicia 38 may be disposed on the membrane 36, and can include an advertisement, team logo or the like. The indicia 38 may be imparted onto the membrane 36 with a photo-receptive ink or similar material that becomes transparent when backlit. Therefor when the electronic device's display is backlit, the indicia 38 may become substantially transparent to allow the user to view through the membrane 36 in a conventional manner. Those skilled in the art can easily ascertain material suitable for this purpose.

However it is also noted that conventional inks, etchings, or other means for providing indicia 38 can be imparted on the solid front surface 52 of the faceplate 50 as seen in FIG. 2. These advertisement or promotion type faceplates may be provided as a ‘sold separately’ unit, such that users can later customize the case device 10 with the faceplate of their choosing. Or businesses can provide them to their customers as a promotional tool.

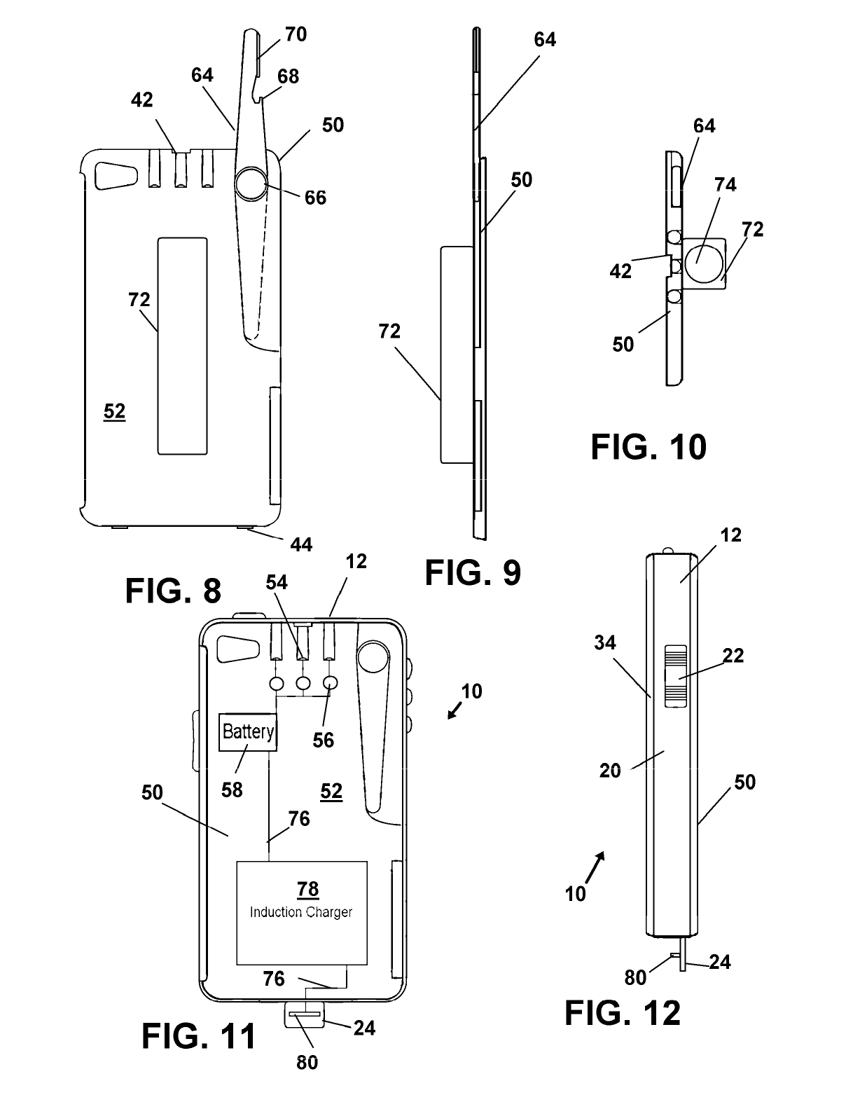

FIG. 8-13 show modes of the faceplate 50 employing various tactical features and components. FIGS. 8-10 show a particularly preferred mode of the rear faceplate 50, employing a rotatable member 64 having a utility blade 70 and bottle opener 68. The member 64 may be engaged to the case 50 by a hinge 66, swivel, or other suitable means for rotatably engagement.

Also included is an elongated container component 72 engaged to the surface 52 of the faceplate 50. The container component 72 includes a cavity 74 for receiving elongated items such as lipstick, lip balm, mace, or the like. However it is noted and anticipated that the container 72 and cavity 74 can be modified in shape and dimension to accommodate various other items such as personal items, credit cards, cash, keys, and the like.

FIG. 11 and FIG. 12 show another particularly preferred mode of the device 10 showing the rear faceplate 50 in the engaged as used mode with the case body 12. In this mode the battery 78 is an in electrical engagement 76 with a induction charging means 78, such as an induction coil conventionally known in the art for wireless power charging. Additionally, means for electrically connecting the induction charging means 78 to the housed electronic device is also provided. When in an electrical engagement with the electronic device, the case device 10 can draw power from the electronic device to charge the onboard battery 58, or alternatively may communicate an electrical charge from the induction charging means 78 to the electronic device's battery. Currently, this may be provided through an electrical engagement 76 of the induction charging means 78 to an electrical connector 80. Currently shown, the electrical connector 80 is disposed on a closure flap 24 which is engaged to the body 12 preferably at the intended charging port location of the housed electronic device. Such flaps are conventionally known in the art of protective cases and provide a means to cover or uncover the area of the electrical connector port of the electronic device as needed for plugging in auxiliary equipment such as a charging cable or data transmission cable (not shown).

Conventionally, this flap is closed when charging isn't required and typically provides a tight seal in order to prevent moisture or dust from communicating into the electrical port. Thus by employing an electrical connector 80 on the flap 24, the user can electrically engage the induction charging means 78 to the electronic device when not employing conventional auxiliary charging or data transmission cables. Preferably, when closed, the flap provides a moisture and dust seal.

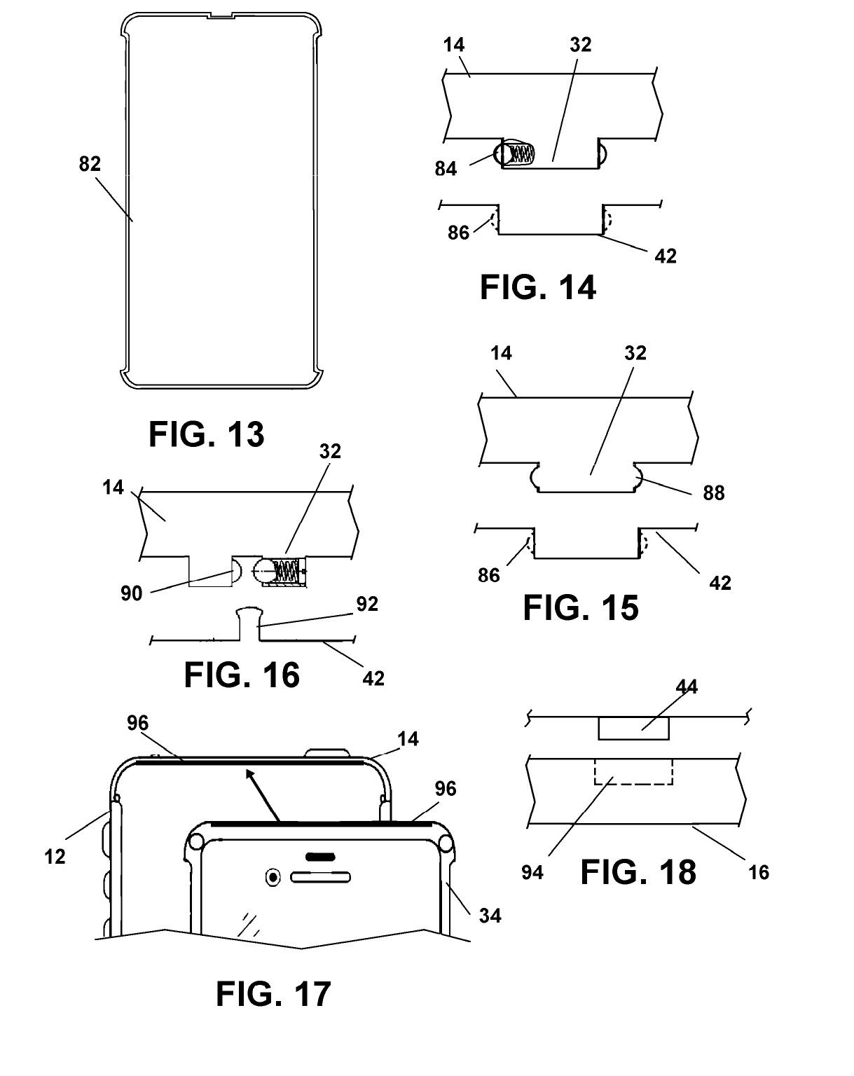

FIG. 13 shows a view of a particularly preferred sealing member 82, in the form of a gasket, O-ring, or the like, employable for an engagement between the faceplates 34, 50 and case body 12 to provide a moisture and dust seal and water barrier. The seal member 82 may be provided as a separate component or may be engaged at or near the circumferential edge of the case body 12 or faceplate 34, 50.

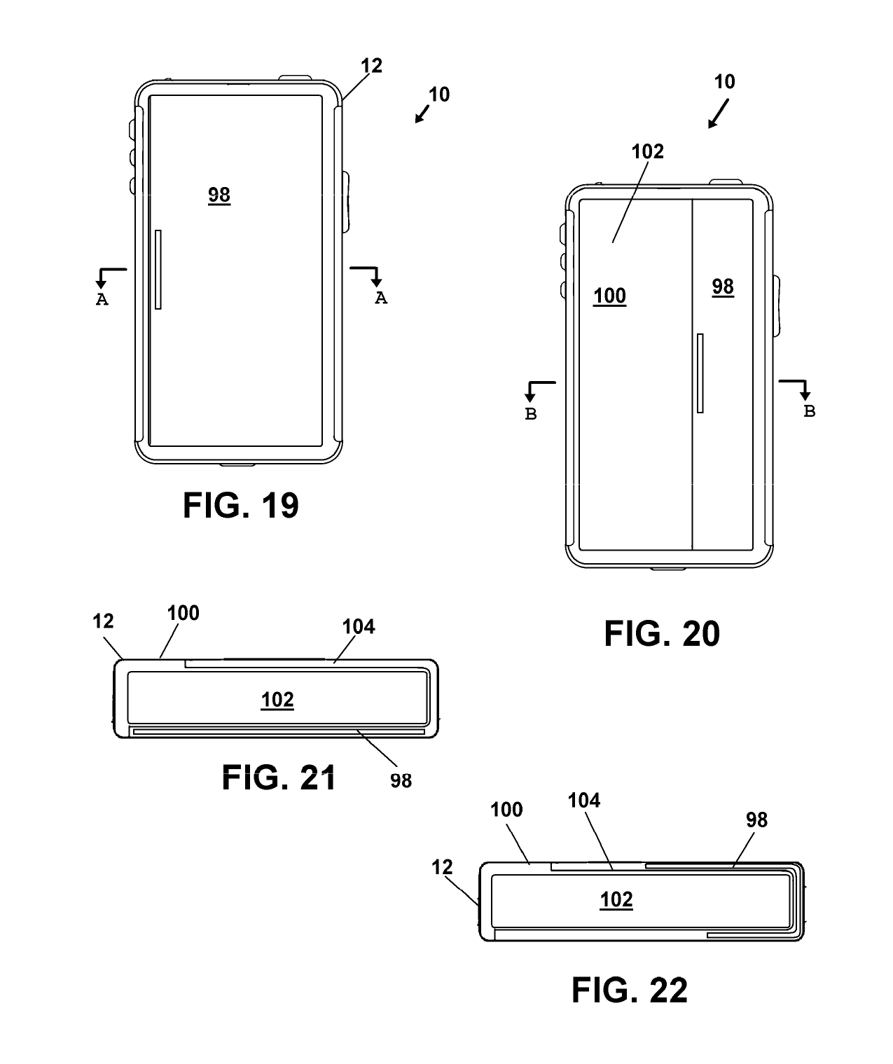

FIG. 19-22 show views of another particularly preferred mode of the case device 10 employing dust and moisture sealing means provided by a slidably engaged front cover 98 engaged within a tracking channel 104 communicating within the sidewalls of the body 12 of the device 10. As shown the cover 98 can be translated from a closed (FIG. 19) to an open position. FIG. 20 shows the slidably cover 98 in an intermediate position when translating the cover from the closed to an open position. The cover 98 is preferably formed of a flexible material facilitating a means for traversing the curves of the channel 104 as shown in the sliced views of FIGS. 21 and 22. However other modes are envisioned wherein the cover 98 is formed from a plurality of interlocking and rotatably engaged panels which facilitate traversing through the channel 104 during a slidable opening or closing of the cover 98. In this mode a permanently engaged rear wall 100 may be provided.

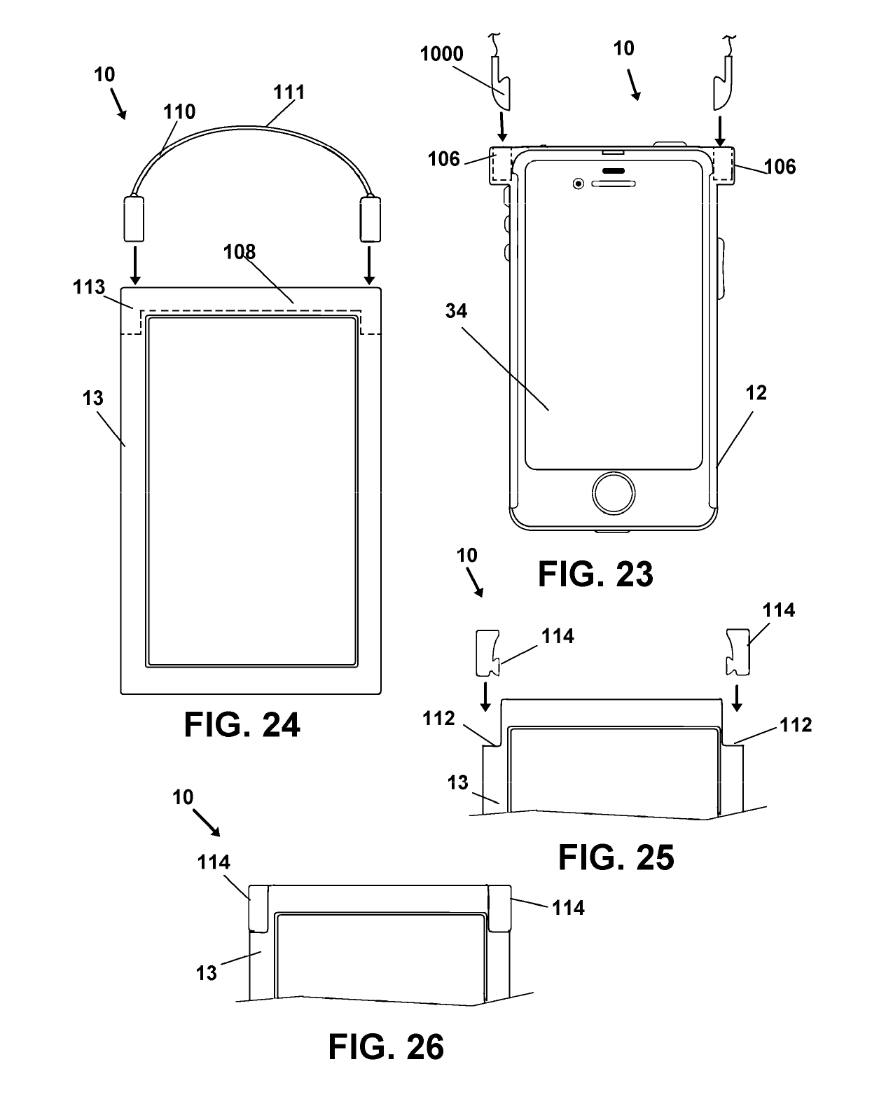

FIG. 23 shows a view of still yet another particularly preferred mode of the device 10 employing means for removable engagement of accessory earbud type headphones 1000. In this mode a receiving cavity 106 provided and engaged to, or formed part of, the case body 12. The cavity portions 106 may be suitably sized and formed to frictionally and removably engage conventional earbud type headphones 1000, both wired and wireless. Those skilled in the art may envision other means for removable engagement of accessory headphones which may slightly or moderately differ than the current depiction in the figure. As such it is noted that the current depiction is provided merely for demonstrative purposes of the intent to provide the user with a temporary storage means for accessories headphones, and should therefor not be considered limiting.

FIG. 24 shows a view of yet another particularly preferred mode of the device 10, showing the body 13 of the device 10 shaped and substantially configured for relatively larger electronic device such as tablet computers. However those skilled in the art will recognize that the dimensional relationships should not be considered limiting. The body 13 of the device 10 employs means for removable engagement of accessory headphones 110. The headphone band 111 is preferably formed form a suitably flexible material to allow the headphones 110 to register in an engagement within a complimentary receiving cavity 113 (shown in dashed lines) provided in the body 13 of the device. Snap fit, slip fit, or other removable engagement means deemed suitable for engaging the headphones 110 within the cavity 113 may be employed, and are anticipated.

FIG. 25 and FIG. 26 show yet another particularly preferred mode of the case device 10 having a body 13 configured for relatively larger electronic device such as tablet computers, employing means for removable engagement of wireless accessory headphones 114. In this mode, the headphones 114 are removably engageable into receiving cavities 112 substantially comprising the corners of the case body 13 as shown. As such, the headphones 114 may be shaped and configured such that in the engaged mode (FIG. 26) the headphones 114 substantially comprise the corner profile of the body 13 of the device 10. This mode is especially preferred in that it maintains the sleek profile of the case device 10 without adding any substantial bulk or clutter to its shape. Engagement of the headphones 114 to the cavities 112 can be snap fits, slip fits, friction engagement, or other suitable engagement means.

Further, it is envisioned that in an engagement of the device 10 with a tablet computer (not shown), the case device 10 can be electrically connected to the tablet in order to communicate the tablet's electrical power to the headphones 114 when engaged to the device 10 for charging the wireless headphones 114 as needed. Those skilled in the art will quickly ascertain various suitable electrical communication means suitable for the intended purpose. This can included wired electrical communication as well as induction charging means.

It is noted that the provisions of any of the features disclosed in the various preferred modes of the invention may be employed solely or in any suitable combination with any other features of the preferred modes and should not be considered limited to the depictions only. It is anticipated that those skilled in the art will envision suitable modifications needed to accomplish such combinations.

This invention has other applications, potentially, and one skilled in the art could discover these. The explication of the features of this invention does not limit the claims of this application; other applications developed by those skilled in the art will be included in this invention.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed:

1. A protective case apparatus, comprising:
a protective casing configured for a removable engagement adjacent to an exterior surface of an electronic device from a group of electronic devices including a smartphone and a pad computer; and
said casing formed of material compressing upon impact thereby providing a dampening of impact of said electronic device when dropped to hit a surface.

2. The protective case apparatus of claim 1, additionally comprising:
an antenna positioned within said protective casing in a mounted position;
said mounted position placing said antenna in a symbiotic engagement with a device antenna engaged with said electronic device when said casing is in said removable engagement with said electronic device; and
said antenna providing a signal gain to said device antenna which is communicated to said device during operation.
